(19) United States
(12) Patent Application Publication
(10) Pub. No.: US 2010/0326324 A1
(43) Pub. Date: Dec. 30, 2010

(54) HEAVY WEIGHT AGGREGATES

(75) Inventors: Yasuhide Higo, Chiba (JP); Minoru Yoshimoto, Chiba (JP); Takeshi Hamada, Tokyo (JP); Eichi Manabe, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Taiheiyo Cement Corporation, Chuo-ku (JP)

(21) Appl. No.: 12/446,680

(22) PCT Filed: Jun. 29, 2007
(86) PCT No.: PCT/JP07/63083

§ 371 Date: Apr. 22, 2009

(30) Foreign Application Priority Data
Nov. 22, 2006 (JP) 2006-316110
Feb. 23, 2007 (JP) 2007-043217
Mar. 20, 2007 (JP) 2007-071758

(51) Int. Cl. C09C 1/24

(52) U.S. Cl. 106/456

(57) ABSTRACT

It is aimed at inexpensively providing a heavy aggregate comprising particles having particle diameters and densities suitable as a fine aggregate of a heavy concrete, heavy mortar, or the like, and there are provided: (i) a heavy aggregate comprising particles including, as a main constituent component, at least one of FeO, Fe₂O₃, and metal iron, characterized in that spherical particles are included in an amount of 20% or more in the whole of particles, and particles passing through a sieve having a nominal size of 0.15 mm are included in an amount of 10% to 20% in mass percentage in the whole of particles; and (ii) the above-described heavy aggregate characterized in that the heavy aggregate is obtained by mutually mixing at least two or more kinds selected from: mill scales brought about in a rolling process of steelmaking; coarse particle components sievedly caught at a particle diameter of 50 μm from steelmaking converter dusts; and pig iron particles separated from blast furnace granulated slags.

### TECHNICAL FIELD

The present invention relates to a heavy aggregate to be used in a heavy concrete, a heavy mortar and the like for a wave-dissipating block, a radiation shielding wall, and the like.

### BACKGROUND ART

The heavy concrete refers to a concrete having a larger weight per unit volume than a typical one, and is used as a wave-dissipating block, a concrete for a river/sea wall, a radiation shielding wall, a bridge weight, and the like. Although iron ores such as magnetite and hematite have been frequently used as heavy aggregates to be used in heavy concretes, it is gradually becoming difficult to obtain high-quality ones as heavy aggregates, and usage of valuable natural resources are undesirable from an economical standpoint as well as an environment-conscious standpoint. Further, although slags such as electric arc furnace oxidizing slags including higher iron contents are used as alternatives to iron ore aggregates, many of such slags have densities less than 4 g/cm³ to result in difficulty in obtaining those having sufficient densities as heavy aggregates. There have been additionally proposed heavy concretes each including steelmaking converter dusts blended with cement (see Patent Document 1, for example). However, steelmaking converter dusts have particle diameters which are not sufficient when they are directly used as fine aggregates of concrete, mortar, or the like, and it is possible to use only coarse particle components sievedly separated therefrom. Although there has been proposed a technique to pelletize the fine particle dust by blending a cement thereto into pellets having diameters of 200 μm or larger to thereby utilize them as aggregates (see Patent Document 2, for example), this leads to a higher cost due to the pellet production step.

Further, it has been proposed in the Patent Document 3 that fine steel particles for shot blast having nominal sieve sizes between 2.5 mm and 0.15 mm are to be used as fine aggregates of heavy concretes by adjusting gradings of the fine particles. However, it is extremely uneconomical to conduct adjustment of grading by blending expensive fine steel particles for shot blast having been produced and adjusted to uniform gradings in various sizes, respectively, so that commercial applications have not been desirably progressed. In turn, it has been proposed to use pig iron particles separated from blast furnace granulated slags, as fine aggregates of heavy concretes, instead of fine steel particles (see Patent Document 4, for example). Although these fine aggregates of heavy concretes are certainly useful as ones of concretes to be used combinedly with coarse aggregates, the fine aggregates are problematic as ones of heavy mortars using only the fine aggregates as detailed later, due to failure of obtainment of sufficient mortar flows or due to occurrence of separation between aggregates and cement pastes.

Patent Document 1: JP-5-319880A

Patent Document 2: JP-6-024813A

Patent Document 3: JP-2-172846A

Patent Document 4: JP-2004-210574A

Nonpatent Literature 1: Japanese Industrial Standard JIS A 5005 Crushed stone and Manufactured sand

Nonpatent Literature 2: Japanese Industrial Standard JIS A 5011-4 Slag Aggregate for Concrete, Part 4: Electric Arc Furnace Oxidizing Slag Aggregate

### DISCLOSURE OF INVENTION

### Problem to be Solved by the Invention

Therefore, the present invention aims at providing an inexpensive heavy aggregate having particle diameters and a density suitable as a fine aggregate of a heavy concrete, a heavy mortar, and the like. Particularly, the present invention aims at providing a heavy and fine aggregate which is useful not only as one to be used combinedly with a coarse aggregate for a heavy concrete but also as one for a heavy mortar.

### Means for Solving Problem

To solve the above problem, the present inventors have earnestly investigated particle shapes and particle size distributions of aggregates for optimum usage as heavy aggregates by variously comparing recycle materials having sufficient densities as heavy aggregates, and have resultingly and exemplarily found such a knowledge that remarkably excellent mortar flows are obtained by a heavy aggregate comprising particles including, as a main constituent component, at least one of FeO, Fe₂O₃, and metal iron, in which spherical particles are included in an amount of 20% or more in the whole of particles, and particles passing through a sieve having a nominal size of 0.15 mm are included in an amount of 10% to 20% in mass percentage in the whole of particles.

Thus, the present invention provides a heavy aggregate comprising particles including, as a main constituent component, at least one of FeO, Fe₂O₃, and metal iron, characterized in that spherical particles are included in an amount of 20% or more in the whole of particles, and particles passing through a sieve having a nominal size of 0.15 mm are included in an amount of 10% to 20% in mass percentage in the whole of particles. Further, the heavy aggregate of the present invention is characterized in that the heavy aggregate includes hot scarves as recycle materials brought about in a scarfing process of a steel slab surface; and that the heavy aggregate is obtained by mixing hot scarves with at least one or more kinds selected from: mill scales brought about in a rolling process of steelmaking; coarse particle components sievedly caught at a particle diameter of 50 μm from steelmaking converter dusts; and pig iron particles separated from blast furnace granulated slags. Furthermore, the heavy aggregate is characterized in that the heavy aggregate is obtained by mutually mixing hot scarves and mill scales, which mill scales are recycle materials brought about in a rolling process of steelmaking, at a mixing volume ratio within a range of 100:0 to 30:70; or in that the heavy aggregate is obtained by mutually mixing: hot scarves; and coarse particle components sievedly caught at a particle diameter of 50 μm from steelmaking converter dusts; at a mixing volume ratio within a range of 100:0 to 70:30; or in that the heavy aggregate is obtained by mutually mixing: hot scarves; and pig iron particles separated from blast furnace granulated slags; at a mixing volume ratio within a range of 100:0 to 70:30.

Moreover, the heavy aggregate of the present invention is also characterized in that the heavy aggregate is obtained by mutually mixing at least two or more kinds selected from: mill scales brought about in a rolling process of steelmaking; coarse particle components sievedly caught at a particle diameter of 50 μm from steelmaking converter dusts; and pig iron particles separated from blast furnace granulated slags; and in that mixing ratios of mill scales, converter dust coarse particle components, and pig iron particles are 20 to 70%, 20 to 50%, and 0 to 40%, respectively, in mass percentage.

### EFFECT OF THE INVENTION

The heavy aggregate of the present invention has an appropriate particle size distribution sought for a fine aggregate of concrete or mortar and contains spherical particles in an appropriate amount, thereby enabling provision of proper flowability and workability for a fresh condition of concrete or mortar, and provision of a sufficient density as a heavy aggregate having a density of 4 g/cm³ or more. Further, the heavy aggregate is obtained by mutually mixing recycle materials brought about in steelmaking processes, so that the heavy aggregate is effective as an alternative to iron ore aggregates as valuable natural resources having a concern about depletion.

### BRIEF DESCRIPTION OF DRAWINGS

FIG. 1 is a graph of a relationship between a mixture ratio of hot scarf (HS) and mill scale (MS) and a mortar flow (Example 3); and

FIG. 2 is a graph of a relationship between a mixture ratio of hot scarf (HS) and mill scale (MS) and a unit volume mass of mortar (Example 3).

### BEST MODE(S) FOR CARRYING OUT THE INVENTION

The heavy aggregate of the present invention will be described in detail hereinafter. In the present invention, heavy aggregates refer to those having saturated surface-dry densities of 4 g/cm³ or more.

The heavy aggregate of the present invention includes, as a main constituent component, at least one of FeO, Fe₂O₃, and metal iron. The phrase “including, as a main constituent component, at least one of FeO, Fe₂O₃, and metal iron” means to include iron in a form of such oxides or metal, and although contents of iron in heavy aggregates are not particularly limited, it is desirable that Fe₂O₃ is 65% or more when constituent elements obtained and determined by fluorescent X-ray analysis are calculated as oxides. In a case that Fe₂O₃ is less than 65% when constituent elements obtained and determined by fluorescent X-ray analysis are calculated as oxides, aggregates possibly have saturated surface-dry densities smaller than 4 g/cm³. More preferably, Fe₂O₃ is 75% or more when constituent elements obtained and determined by fluorescent X-ray analysis are calculated as oxides, and heavy aggregates are then caused to have saturated surface-dry densities of 4.5 g/cm³ or more. Thus, the heavy aggregate of the present invention preferably has a saturated surface-dry density of 4.5 g/cm³ or more.

Since larger differences of density are present between heavy aggregates and cement pastes, such aggregates tend to be separated from the pastes upon cast of concretes or mortars. It is thus required to ensure flowability by means of shapes of heavy aggregates. The heavy aggregate of the present invention has a higher flowability because spherical particles included in the whole of particles (hereinafter abbreviatedly and simply expressed as “spherical particles”) are 20% or more, so that the heavy aggregate can be casted without separation thereof from a cement paste upon usage in concrete or mortar. When spherical particles are less than 20%, aggregates and pastes are possibly separated from each other upon cast of concretes or mortars.

Optimum particle size distributions of fine aggregates to be used for concretes and mortars are to vary depending on shapes, surface roughnesses, mix proportions, and the like of the aggregates. For example, according to the JIS standard of manufactured sand (A 5005; Nonpatent Literature 1), particle size distributions are prescribed as listed in Table 1, such that those particles of the whole of particles which are passed through a sieve having a nominal size of 0.15 mm are 2% to 15% in mass percentage. Meanwhile, according to the JIS standard of electric arc furnace oxidizing slag aggregate (A 5011-4: Nonpatent Literature 2), it is noted in its explanation that larger contents of fine particles obtain more excellent conditions of fresh concretes, such that, in case of a 1.2 mm electric arc furnace oxidizing slag aggregate, those particles of the whole of particles which are passed through a sieve having a nominal size of 0.15 mm are 10% to 30% in mass percentage. However, no knowledges have been disclosed up to now, concerning optimum particle size distributions for obtaining excellent conditions of fresh concretes, in case of heavy aggregates which have densities of 4.5 g/cm³ or more and which include 20% or more of spherical particles in the whole of particles.

Although the Patent Document 3 suggests that fine steel particles for shot blast are blendedly used as fine aggregates for heavy concretes, the fine particles are adjusted to simply meet particle size distributions prescribed in JASS5 (Architectural Institute of Japan, standard construction work specification 5, reinforced concrete construction), and no considerations are provided about detailed particle size distributions of heavy aggregates so as to obtain excellent fresh conditions of concretes and mortars.

The present inventors have detailedly investigated particle size distributions of heavy aggregates for obtaining excellent mortar flows, and have narrowly found out the optimum particle size distributions listed in Table 1. Namely, the heavy aggregate of the present invention is characterized in that particles passing through a sieve having a nominal size of 0.15 mm are included in an amount of 10% to 20% in mass percentage in the whole of particles. When particles passing through a sieve having a nominal size of 0.15 mm are included in an amount less than 10% or larger than 20% in mass percentage in the whole of particles, it is likely that sufficient mortar flows are not obtained, or separations between aggregates and cement pastes are caused.

TABLE 1

| | Mass percentage (%) of matter passing through sieve | | |
|---|---|---|---|
| Nominal | | 1.2 mm electric | |
| size of | | arc furnace | Heavy aggregate |
| sieve | Manufactured | oxidizing slag | of present |
| (mm) | sand JIS | aggregate JIS | invention |
| 5 | 90 to 100 | 100 | 97 to 100 |
| 2.5 | 80 to 100 | 95 to 100 | 90 to 98 |
| 1.2 | 50 to 90 | 80 to 100 | 70 to 90 |
| 0.6 | 25 to 65 | 35 to 80 | 45 to 70 |
| 0.3 | 10 to 35 | 15 to 50 | 20 to 50 |
| 0.15 | 2 to 15 | 10 to 30 | 10 to 20 |

Further, it is desirable that particles passing through a sieve having a nominal size of 0.12 mm are included in an amount of 70% to 90% in mass percentage in the whole of particles. When particles passing through a sieve having a nominal size of 1.2 mm are included in an amount less than 70% or larger than 90% in mass percentage in the whole of particles, it is likely that sufficient mortar flows are not obtained, or separations between aggregates and cement pastes are caused. Furthermore, it is desirable that the heavy aggregate of the present invention is obtained by mixing recycle materials brought about in steelmaking processes.

Meanwhile, in case of a steel slab produced by continuous casting, inclusions such as Al are continuously deposited on a longitudinal surface layer portion of the steel slab due to an inflow of molten steel into a mold. Further, in a process for scarfing and removing the surface inclusions of the steel slab, hot scarves are brought about as recycle materials, and such hot scarves include FeO, Fe₂O₃, and metal iron as main constituent components, such that Fe₂O₃ is 80% or more when constituent elements obtained and determined by fluorescent X-ray analysis are calculated as oxides, while saturated surface-dry densities of the hot scarves become 4.8 g/cm³ or more. Moreover, spherical particles are included in such hot scarves in an amount of about 70%, and particles passing through a sieve having a nominal size of 0.15 mm are included within a range of 10% to 20% in mass percentage in the whole of particles, so that the hot scarves can be directly used as the heavy aggregate of the present invention.

However, generated amounts of such recycle materials are not so much, so that they are to be desirably used in combination with other recycle materials. For example, in case of coarse powder components sievedly caught at 50 μm from steelmaking converter dusts, it is possible to mix up to 30 parts of coarse converter dust powders with down to 70 parts of hot scarves in volume ratio. Mixing more parts of coarse converter dust powders results in that particles passing through a sieve having a nominal size of 0.15 mm are included in an amount exceeding 20% in mass percentage in the whole of particles of the mixture, so that sufficient mortar flows are not possibly obtained.

In turn, also pig iron particles separated from blast furnace granulated slags in a pulverizing process, include metal iron as main components, exhibit saturated surface-dry densities of 4.8 g/cm³ or more, and include about 50% of particles having substantially spherical shapes, so that the pig iron particles are recycle materials which can be used by mixing them with hot scarves. It is possible to mix up to 30 parts of pig iron particles with down to 70 parts of hot scarves in volume ratio. Mixing more parts of pig iron particles results in that particles passing through a sieve having a nominal size of 0.15 mm are included in an amount less than 10% in mass percentage in the whole of particles of the mixture, so that sufficient mortar flows are not possibly obtained.

On the other hand, mill scales as recycle materials brought about in a rolling process of steelmaking also include FeO, Fe₂O₃, and metal iron as main constituent components, such that Fe₂O₃ is 80% or more when constituent elements obtained and determined by fluorescent X-ray analysis are calculated as oxides, while saturated surface-dry densities of the mill scales become 4.8 g/cm³ or more. Further, mill scales are slightly shifted to a coarse particle side closer than hot scarves, and have a particle size distribution close to the manufactured sand JIS. Moreover, generated amounts of mill scales as recycle materials are relatively large. However, most of particles of mill scales are flat, so that adoption thereof as aggregates tends to decrease flowabilities of concretes or mortars, and excessive increase of water content per unit volume and/or water reducing agent amount easily results in separation between aggregates and pastes. It is thus impossible to directly use mill scales solely as heavy aggregates.

The present inventors have mutually mixed hot scarves and mill scales at various mixing ratios, to investigate relevancy thereof as heavy aggregates. As a result, it has been confirmed that up to 70 parts of mill scales can be mixed with down to 30 parts of hot scarves, in volume ratio. Mixing more amounts of mill scales results in ratios of spherical particles less than 20% to thereby fail to ensure flowabilities, thereby possibly failing to obtain sufficient mortar flows. In turn, increasing water contents per unit volume so as to obtain sufficient mortar flows, possibly causes separation between aggregates and cement pastes. Note that it is more desirable to provide hot scarves and mill scales at a mixing volume ratio of 40:60 therebetween, or at ratios of hot scarves larger than this ratio, because air is then apt to exit from mortars, and unit volume masses of mortars can be increased.

“Spherical particles” in the present invention will be now described in detail. As expressed, spherical particles are particles having substantially spherical shapes. Examples of production processes of spherical particles include: (1) a situation where a solid is melted into a liquid by heat, followed by cooling in air to thereby solidify into a nearly spherical shape having a minimum surface area per unit volume; (2) a situation where an aspherical particle is physically ground and loses corners thereof, into a nearly spherical shape; and (3) powder particles, or fine particles deposited from a solution, are bonded to a periphery of a nucleus, and grown into a nearly spherical shape. Although particles in continuous shapes from spherical to aspherical are produced in the situations (2) and (3), no particles in intermediate shapes are produced in the situation (1).

As described above, hot scarves are recycle materials to be brought about in a process for scarfing and removing surface inclusions of steel slabs, and spherical particles thereof are produced in the production process (1). Although coarse converter dust powders and pig iron particles also include spherical particles, production processes thereof are considered to include not only the situation (1) but also the situation (2).

While the heavy aggregate of the present invention is required to include 20% or more of “spherical particles” in the whole of particles, it is desirable that “spherical particles” having distortion irregularities of 3.3 or less are included in an amount of 20% or more in the whole of particles.

Here, the “distortion irregularity” is defined by the following equation:

[Distortion irregularity]=[Length of circumferential outline of particle]/[Diameter of true circle having the same area as the area of the particle providing the outline]

Namely, particles are visually inspected by images of a scanning electron microscope (SEM), to exclude those particles therefrom which are judged to be disk-like or hemispherical shapes, and the particles apparently having nearly spherical shapes are analyzed by image processing. The image processing may be conducted by adopting a typical image processing software (such as “Adobe Photoshop” [Registered Trade-Mark] (sold by ADOBE SYSTEMS INCORPORATED)). Then, shadows are erased from an image of a nearly spherical particle to form a graphic figure having an outline only, and to obtain an area and a length of circumferential outline of the graphic figure. Further, the graphic figure is approximated to a circle (i.e., there is assumed a circle having the same area as the graphic figure), and there are then obtained a radius “r” from the area πr² of the circle, and a diameter which is two times the radius. As outlines become closer to circles, i.e., as particles become closer to spherical shapes, ratios of circumferential lengths to diameters are decreased, and the ratios are brought to have values close to a circle ratio π. In this connection, distortion irregularities become 3.2 or less, in case of spherical particles included in hot scarves.

In obtaining a ratio of spherical particles in the whole of particles, although it is desirable to count the number of all particles captured in each SEM photograph and the number of spherical particles therein and to obtain an averaged value of the ratios, there are practically counted only those particles having diameters larger than a certain value such as 50 μm while assuming that ratios of spherical particles are constant irrespectively of diameters of the particles.

Meanwhile, the heavy aggregate of the present invention can also be obtained by mutually mixing at least two or more kinds selected from: mill scales brought about in a rolling process of steelmaking; coarse particle components sievedly caught at a particle diameter of 50 μm from steelmaking converter dusts; and pig iron particles separated from blast furnace granulated slags. All the mill scales, converter dust coarse particle components, and pig iron particles are recycle materials provided in larger generated amounts than hot scarves to be brought about in a scarfing process of steel slab surface.

Mill scales are recycle materials brought about in a rolling process of steelmaking, and include Fe₂O₃ in an amount of 80% or more when constituent elements obtained and determined by fluorescent X-ray analysis are calculated as oxides, while saturated surface-dry densities of the mill scales become 4.8 g/cm³ or more. Moreover, mill scales have a particle size distribution close to the manufactured sand JIS as listed in Table 2. However, most of particles of mill scales are flat, so that adoption thereof as aggregates tends to decrease flowabilities of concretes or mortars, and excessive increase of water content per unit volume and/or water reducing agent amount easily results in separation between aggregates and pastes. It is thus impossible to directly use mill scales solely as heavy aggregates.

Although coarse particle components of steelmaking converter dusts include spherical particles in an amount of 70% or more, the coarse particle components exhibit particle size distributions excessively deviated to a fine particle side insofar as used as aggregates such that particles passing through a sieve having a nominal size of 0.15 mm are included in an amount of 25% or more and particles passing through a sieve having a nominal size of 0.3 mm are included in an amount of 65% or more, in mass percentage in the whole of particles, so that the particles tend to agglomerate, and thus sufficient mortar flows are difficult to be obtained when coarse converter dust powders are solely used as heavy aggregates.

Although pig iron particles separated from blast furnace granulated slags also include spherical particles in an amount of about 50%, the pig iron particles exhibit deviated particle size distributions concentrated between particle diameters of 0.3 mm and 1.2 mm such that particles passing through a sieve having a nominal size of 0.15 mm are included in an amount of 5% or less and particles passing through a sieve having a nominal size of 0.3 mm are included in an amount of 20% or less while particles passing through a sieve having a nominal size of 1.2 mm are included in an amount of 85% or more, in mass percentage in the whole of particles. As such, when pig iron particles are solely used as heavy aggregates, separation tends to be caused between aggregates and cement pastes.

As described above, when the three kinds of recycle materials are each used solely as heavy aggregates, sufficient mortar flows are not obtained, or separation tends to be caused between aggregates and cement pastes. However, by mutually mixing at least two or more kinds of the three kinds of recycle materials at suitable mixing ratios, there can be obtained heavy aggregates which cause no separation between aggregates and cement pastes while allowing mortars to have sufficient flowabilities and workabilities.

TABLE 2

| | Mass percentage (%) of matter passing through sieve | | | |
|---|---|---|---|---|
| | | | Converter | |
| Nominal | | | dust | |
| size of | | | coarse | |
| sieve | Manufactured | | particle | Pig iron |
| (mm) | sand JIS | Mill scale | component | particle |
| 5 | 90 to 100 | 95 to 100 | 100 | 100 |
| 2.5 | 80 to 100 | 85 to 90 | 95 to 100 | 95 to 100 |
| 1.2 | 50 to 90 | 60 to 70 | 90 to 100 | 85 to 95 |
| 0.6 | 25 to 65 | 35 to 45 | 85 to 95 | 45 to 65 |
| 0.3 | 10 to 35 | 15 to 25 | 65 to 85 | 10 to 20 |
| 0.15 | 2 to 15 | 5 to 10 | 25 to 45 | 0 to 5 |

In the heavy aggregate of the present invention, mill scales, converter dust coarse particle components, and pig iron particles are included at mixing ratios of, preferably 0 to 70%, 0 to 50%, and 0 to 60%, respectively, and more preferably 20 to 70%, 20 to 50%, and 0 to 40%, respectively, in mass percentage.

Mixing ratios of mill scales exceeding 70% or mixing ratios of converter dust coarse particle components exceeding 50% in heavy aggregates may undesirably result in failure of obtainment of sufficient mortar flows in mortars adopting the heavy aggregates. Mixing ratios of pig iron particles exceeding 60% in heavy aggregates may undesirably result in separation between heavy aggregates and cement pastes in mortars adopting the aggregates.

Mixing ratios of mill scales less than 20% of heavy aggregates may result in occurrence of separation between heavy aggregates and cement pastes, or in failure of obtainment of sufficient mortar flows in mortars adopting the aggregates, depending on mixing ratios of the other recycle materials. Mixing ratios of converter dust coarse particle components less than 20% or mixing ratios of pig iron particles exceeding 40% of heavy aggregates may result in separation between heavy aggregates and cement pastes in mortars adopting the aggregates, depending on mixing ratios of the other recycle materials.

### EXAMPLES

Although the present invention will be concretely described with reference to Examples and Comparative Examples, the present invention is not limited to these Examples insofar as within the scope of the present invention.

### Example 1

### Testing Method

(1) Mutually and variously mixed were hot scarves having a saturated surface-dry density of 5.08 g/cm³ and including spherical particles in an amount of about 75%, and coarse converter dust powders having a saturated surface-dry density of 5.84 g/cm³ and including spherical particles in an amount of about 73%, thereby preparing mixed sands 1 to 4 having particle size distributions listed in Table 2. (Mixing volume ratio of mixed sand 2:hot scarf 70:coarse converter dust powder 30.)

(2) Mixed into each of the mixed sands prepared in step (1) was a normal Portland cement at a sand-cement volume ratio of 3.19, followed by kneading after addition of 4.37 kg/m³ of a high-performance AE water reducing agent (air entraining and water reducing agent) based on polycarboxylic ether, 0.22 kg/m³ of an anti-foaming agent, and 246 kg/m³ of water (water-cement ratio of 45.0%), per 547 kg/m³ of cement.

(3) Using a flow cone having a diameter of 100 mm and a height of 40 mm prescribed in the physical testing method of cement according to JIS R 5201, the mortars prepared in step (2) were each filled into the flow cone, followed by pull-up of the flow cone, to measure mortar flows, respectively.

(Test Result)

Measurement results of mortar flows are listed in Table 3.

TABLE 3

| | |
|---|---|
| Mass percentage (%) of matter | |
| passing through sieve | Mortar |
| Sieve size (mm) | flow |

| | 5 | 2.5 | 1.2 | 0.6 | 0.3 | 0.15 | (mm) |
|---|---|---|---|---|---|---|---|
| Mixed | 99 | 97 | 85 | 59 | 33 | 14 | 190 |
| sand 1 | | | | | | | |
| Mixed | 100 | 97 | 88 | 69 | 46 | 20 | 160 |
| sand 2 | | | | | | | |
| Mixed | 100 | 97 | 90 | 75 | 54 | 24 | 105 |
| sand 3 | | | | | | | |
| Mixed | 100 | 97 | 96 | 92 | 75 | 34 | 100 |
| sand 4 | | | | | | | |

Seen from the results listed in Table 3 is that excellent mortar flows were obtained by the mixed sands 1 and 2, respectively. The mixed sand 4 included densely packed particles having small diameters such that even kneading was difficult and no flows of the mortar was found. The mixed sand 3 provided a slight mortar flow, and increase of a water-cement ratio up to 50% provided an increase of mortar flow up to 130 mm, though the details thereof are not shown. However, separation was then caused between the aggregates and the cement paste. As described above, it has become apparent that remarkably significant effects can be obtained in mortar flows, by limiting particle size distributions of heavy aggregates such that particles passing through a sieve having a nominal size of 0.15 mm are included at 20% or less in mass percentage in the whole of particles.

### Example 2

### Testing Method

(1) Mutually and variously mixed were hot scarves having a saturated surface-dry density of 5.08 g/cm³ and including spherical particles in an amount of about 75%, and pig iron particles (magnetically separated from blast furnace granulated slags in a pulverizing process) having a saturated surface-dry density of 5.60 g/cm³ and including spherical particles in an amount of about 54%, thereby preparing mixed sands 5 to 10 having particle size distributions listed in Table 4. (Mixing volume ratio of mixed sand 7:hot scarf 70:pig iron particle 30.)

(2) Mixed into each of the mixed sands prepared in step (1) was a normal Portland cement at a sand-cement volume ratio of 3.19, followed by kneading after addition of 5.46 kg/m³ of a high-performance AE water reducing agent based on polycarboxylic ether, 0.22 kg/m³ of an anti-foaming agent, and 246 kg/m³ of water (water-cement ratio of 45.0%), per 547 kg/m³ of cement.

(3) Similarly to Example 1, mortar flows were measured.

(Test Result)

Measurement results of mortar flows are listed in Table 4.

TABLE 4

| | |
|---|---|
| Mass percentage (%) of matter | |
| passing through sieve | Mortar |
| Sieve size (mm) | flow |

| | 5 | 2.5 | 1.2 | 0.6 | 0.3 | 0.15 | (mm) |
|---|---|---|---|---|---|---|---|
| Mixed | 99 | 97 | 85 | 59 | 33 | 14 | 190 |
| sand 5 | | | | | | | |
| Mixed | 100 | 98 | 87 | 58 | 30 | 12 | 180 |
| sand 6 | | | | | | | |
| Mixed | 100 | 98 | 87 | 58 | 28 | 10 | 150 |
| sand 7 | | | | | | | |
| Mixed | 100 | 98 | 88 | 57 | 26 | 9 | 130 |
| sand 8 | | | | | | | |
| Mixed | 100 | 98 | 91 | 56 | 21 | 6 | 125 |
| sand 9 | | | | | | | |
| Mixed | 100 | 99 | 93 | 54 | 16 | 2 | 115 |
| sand10 | | | | | | | |

Seen from the results listed in Table 4 is that excellent mortar flows were obtained by the mixed sands 5, 6, and 7, respectively. Contrary, flowabilities of mortars were apparently lowered in the mixed sands 8, 9, and 10. Further, slight separation was caused between aggregates and cement pastes, in case of the mixed sands 9 and 10. As described above, it has become apparent that remarkably significant effects can be obtained in mortar flows, by limiting particle size distributions of heavy aggregates such that particles passing through a sieve having a nominal size of 0.15 mm are included at 10% or more in mass percentage in the whole of particles.

### Example 3

### Testing Method

(1) Mutually mixed at various volume ratios were hot scarves having a saturated surface-dry density of 5.08 g/cm³ and including spherical particles in an amount of about 75%, and mill scales constituted of flat particles having a saturated surface-dry density of 4.95 g/cm³, thereby preparing mixed sands 11 to 18.

(2) Mixed into each of the mixed sands prepared in step (1) was a normal Portland cement at a sand-cement volume ratio of 2.68, followed by kneading after addition of 5.84 kg/m³ of a high-performance AE water reducing agent based on polycarboxylic ether, 0.23 kg/m³ of an anti-foaming agent, and 292 kg/m³ of water (water-cement ratio of 50.0%), per 584 kg/m³ of cement.

(3) Similarly to Example 1, mortar flows were measured. Further, unit volume masses of the mortars were measured, respectively.

(Test Result)

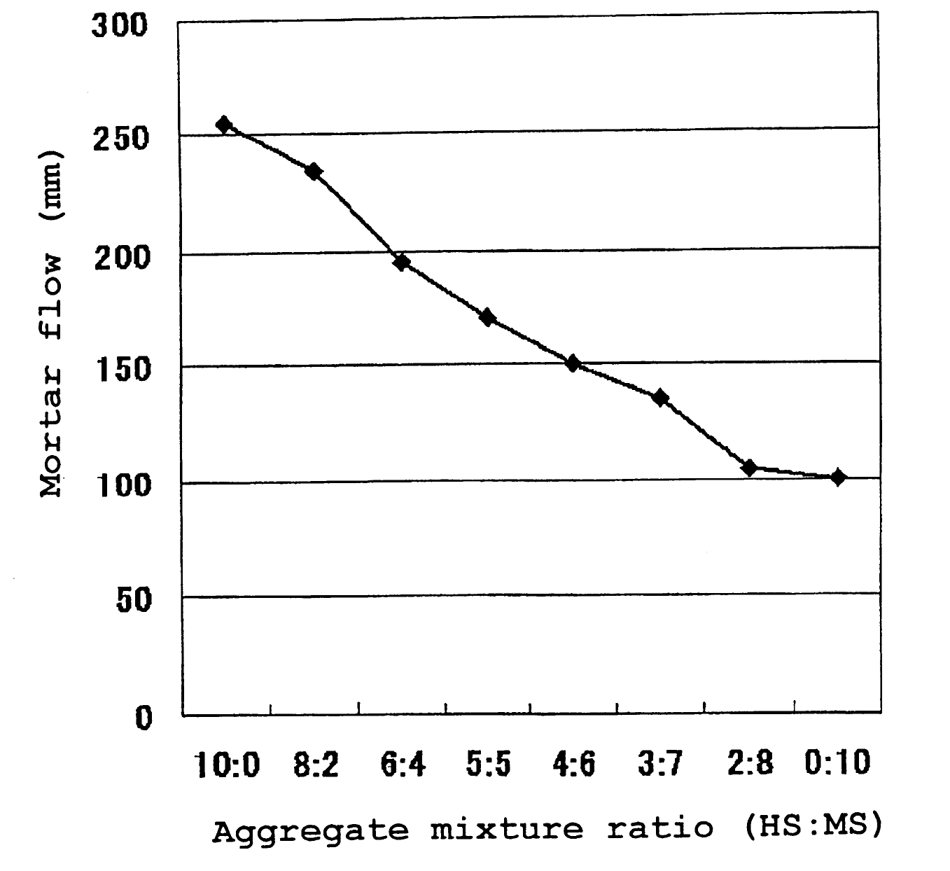

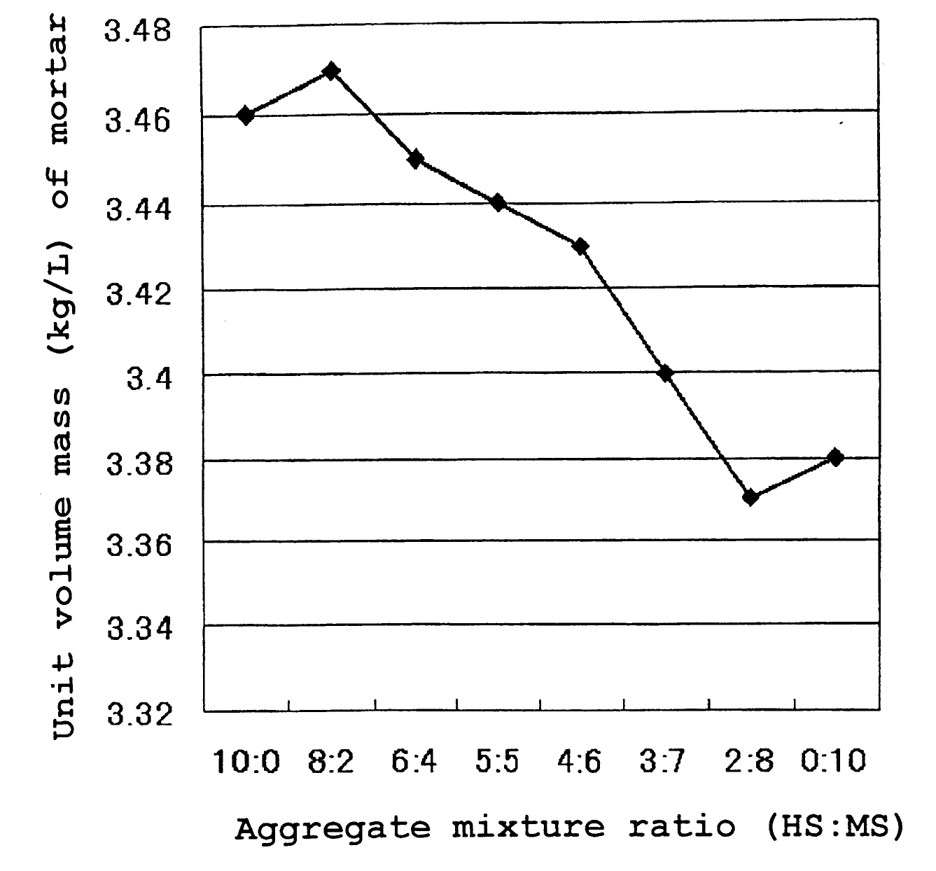

The measurement results of mortar flows are shown in FIG. 1, and unit volume masses of the mortars are shown in FIG. 2.

Mortar flow was hardly seen at a mixture ratio of 20:80 between hot scarves (HS) and mill scales (MS), and separation was seen between the aggregates and the cement paste. Larger mixture ratios of hot scarves than 30:70 resulted in obtainment of excellent mortar flows. At this time, ratios of spherical particles were 20% or more.

From a point of mixture ratio of 40:60 between hot scarves and mill scales, larger mixture ratios of hot scarves resulted in remarkably large unit volume masses of the mortars, thereby exemplifying higher desirability. At this time, ratios of spherical particles were 25% or more.

### Example 4

### Testing Method

(1) Mutually mixed at ratios of 30 to 80%, 0 to 60%, and 0 to 60% in mass percentage, were: mill scales constituted of flat particles and having a saturated surface-dry density of 4.95 g/cm³; converter dust coarse powder components (coarse dust particles) having a saturated surface-dry density of 5.84 g/cm³ and including spherical particles in an amount of about 73%; and pig iron particles (magnetically separated from blast furnace granulated slags in a pulverizing process) having a saturated surface-dry density of 5.60 g/cm³ and including spherical particles in an amount of about 54%; to prepare mixed sands, respectively.

(2) Mixed into each of the mixed sands prepared in step (1) was a normal Portland cement at a sand-cement volume ratio of 2.68, followed by kneading after addition of 5.84 kg/m³ of a high-performance AE water reducing agent based on polycarboxylic ether, 0.23 kg/m³ of an anti-foaming agent, and 292 kg/m³ of water (water-cement ratio of 50.0%), per 584 kg/m³ of cement.

(3) Similarly to Example 1, mortar flows were measured.

(Test Result)

The measurement results of mortar flows are listed in Table 5. Mortar flows were judged to be excellent at values of 130 mm or more.

TABLE 5

| | Aggregate mixing ratio (%) | | | | | |
|---|---|---|---|---|---|---|
| | | Coarse | | Mortar | | |
| | Mill | dust | Pig iron | flow | Separation | |
| No. | scale | particle | particle | (mm) | state | Judgment |
| 1 | 80 | 20 | 0 | 115 | ◯ | X |
| 2 | | 10 | 10 | 100 | ◯ | X |
| 3 | | 0 | 20 | 100 | ◯ | X |
| 4 | 70 | 30 | 0 | 135 | ◯ | ◯ |
| 5 | | 20 | 10 | 140 | ◯ | ◯ |
| 6 | | 10 | 20 | 130 | ◯ | Δ |
| 7 | | 0 | 30 | 130 | Δ | Δ |
| 8 | 60 | 40 | 0 | 140 | ◯ | ◯ |
| 9 | | 30 | 10 | 155 | ◯ | ◯ |
| 10 | | 20 | 20 | 160 | ◯ | ◯ |
| 11 | | 10 | 30 | 145 | Δ | Δ |
| 12 | | 0 | 40 | 140 | X | X |
| 13 | 50 | 50 | 0 | 130 | ◯ | Δ |
| 14 | | 40 | 10 | 145 | ◯ | ◯ |
| 15 | | 30 | 20 | 155 | ◯ | ◯ |
| 16 | | 20 | 30 | 155 | ◯ | ◯ |
| 17 | | 10 | 40 | 150 | Δ | Δ |
| 18 | | 0 | 50 | 140 | X | X |
| 19 | 40 | 60 | 0 | 120 | ◯ | X |
| 20 | | 50 | 10 | 145 | ◯ | ◯ |
| 21 | | 40 | 20 | 165 | ◯ | ◯ |
| 22 | | 30 | 30 | 170 | ◯ | ◯ |
| 23 | | 20 | 40 | 160 | Δ | Δ |
| 24 | | 10 | 50 | 160 | X | X |
| 25 | | 0 | 60 | 145 | X | X |
| 26 | 30 | 60 | 10 | 120 | Δ | X |
| 27 | | 50 | 20 | 140 | ◯ | ◯ |
| 28 | | 40 | 30 | 175 | ◯ | ◯ |
| 29 | | 30 | 40 | 180 | Δ | Δ |
| 30 | | 20 | 50 | 170 | X | X |

Separation state:
X: recognition of separation between cement paste and aggregate
Δ: recognition of slight separation
◯: no separation
Judgment:
◯: particularly excellent
Δ: substantially excellent
X: undesirable

### Example 5

### Testing Method

(1) Mutually mixed at ratios of 0 to 30%, 10 to 60%, and 10 to 70% in mass percentage, were mill scales, converter dust coarse powder components, and pig iron particles as noted above, to prepare mixed sands, respectively.

(2) Mixed into each of the mixed sands prepared in step (1) was a normal Portland cement at a sand-cement volume ratio of 3.19, followed by kneading after addition of 5.46 kg/m³ of a high-performance AE water reducing agent based on polycarboxylic ether, 0.22 kg/m³ of an anti-foaming agent, and 246 kg/m³ of water (water-cement ratio of 45.0%), per 547 kg/m³ of cement.

(3) Similarly to Example 1, mortar flows were measured.

(Test Result)

The measurement results of mortar flows are listed in Table 6. Mortar flows were judged to be excellent at values of 130 mm or more.

TABLE 6

| | Aggregate mixing ratio (%) | | | | | |
|---|---|---|---|---|---|---|
| | | Coarse | | Mortar | | |
| | Mill | dust | Pig iron | flow | Separation | |
| No. | scale | particle | particle | (mm) | state | Judgment |
| 31 | 30 | 60 | 10 | 105 | ◯ | X |
| 32 | | 50 | 20 | 120 | ◯ | X |
| 33 | | 40 | 30 | 145 | ◯ | ◯ |
| 34 | | 30 | 40 | 150 | ◯ | ◯ |
| 35 | | 20 | 50 | 135 | X | X |
| 36 | | 10 | 60 | 140 | X | X |
| 37 | 20 | 60 | 20 | 110 | ◯ | X |
| 38 | | 50 | 30 | 130 | ◯ | Δ |
| 39 | | 40 | 40 | 155 | ◯ | ◯ |
| 40 | | 30 | 50 | 150 | Δ | Δ |
| 41 | | 20 | 60 | 140 | X | X |
| 42 | | 10 | 70 | 145 | X | X |
| 43 | 10 | 60 | 30 | 105 | ◯ | X |
| 44 | | 50 | 40 | 125 | ◯ | X |
| 45 | | 40 | 50 | 140 | Δ | Δ |
| 46 | | 30 | 60 | 145 | X | X |
| 47 | | 20 | 70 | 150 | X | X |
| 48 | 0 | 50 | 50 | 120 | ◯ | X |
| 49 | | 40 | 60 | 130 | Δ | Δ |
| 50 | | 30 | 70 | 120 | X | X |

Separation state:
X: recognition of separation between cement paste and aggregate
Δ: recognition of slight separation
◯: no separation
Judgment:
◯: particularly excellent
Δ: substantially excellent
X: undesirable

Generally, larger water-cement ratios lead to higher flowabilities of mortars and to susceptibilities of separation between cement pastes and aggregates, while smaller water-cement ratios lead to insusceptibilities of separation between cement pastes and aggregates and lower flowabilities of mortars. Meanwhile, since larger mixing ratios of mill scales lead to lower flowabilities, and larger mixing ratios of pig iron particles tend to cause susceptibilities of separation between cement pastes and aggregates, Example 4 was prepared to attain mixing ratios of mill scales of 30% or more and the water-cement ratio of 50.0%, and Example 5 was prepared to attain mixing ratios of mill scales of 30% or less and the water-cement ratio of 45.0%. From the results listed in Table 5 and Table 6, it has become apparent that mixing ratios of mill scales, converter dust coarse particle components, and pig iron particles, as heavy aggregates to be used in heavy mortars, are preferably 0 to 70%, 0 to 50%, and 0 to 60%, respectively, and more preferably 20 to 70%, 20 to 50%, and 0 to 40%, respectively, in mass percentage.

Note that when the mixing ratios of mill scales, converter dust coarse particle components, and pig iron particles are 0 to 70%, 0 to 50%, and 0 to 60%, respectively, in mass percentage, the heavy aggregates have satisfied the requirements that: each heavy aggregate comprising particles includes, as a main constituent component, at least one of FeO, Fe₂O₃, and metal iron; spherical particles are included in an amount of 20% or more in the whole of particles; particles passing through a sieve having a nominal size of 0.15 mm are included in an amount of 10% to 20% in mass percentage in the whole of particles; and particles passing through a sieve having a nominal size of 1.2 mm are included in an amount of 70% to 90% in mass percentage in the whole of particles. Further, the heavy aggregates each have satisfied the particle size distribution of the heavy aggregate of the present invention shown in Table 1 over the whole grading range.

The present application is based on:

Japanese patent application No. 2006-316110 filed on Nov. 22, 2006;

Japanese patent application No. 2007-043217 filed on Feb. 23, 2007; and

Japanese patent application No. 2007-071758 filed on Mar. 20, 2007; and

the contents thereof are incorporated herein in their entireties by reference, as the disclosure of the specification of the present application.

1-17. (canceled)

18. A heavy aggregate comprising particles comprising at least one member selected from the group consisting of FeO, Fe₂O₃ and metallic iron as a main component;
wherein:
at least 20% of the particles are spherical particles;
from 10 to 20% by mass of the particles are capable of passing through a sieve having a nominal size of 0.15 mm; and
the spherical particles are derived from hot scarves obtained by scarfing a steel slab surface.

19. The heavy aggregate of claim 18, wherein the heavy aggregate is obtained by mixing hot scarves and mill scales at a mixing volume ratio of from 100:0 to 30:70.

20. The heavy aggregate of claim 18, wherein the heavy aggregate is obtained by mixing:
hot scarves; and
coarse particle components obtained by sieving steelmaking converter dusts to a particle diameter of 50 μm;
wherein the hot scarves and coarse particle components are mixed at a mixing volume ratio of from 100:0 to 70:30.

21. The heavy aggregate of claim 18, wherein the heavy aggregate is obtained by mixing:
hot scarves; and
pig iron particles separated from blast furnace granulated slags;
wherein the hot scarves and pig iron particles are mixed at a mixing volume ratio of from 100:0 to 70:30.

22. The heavy aggregate of claim 18, wherein the heavy aggregate is obtained by mixing hot scarves with at least one member selected from the group consisting of:
mill scales obtained from a rolling process in steelmaking;
coarse particle components obtained by sieving steelmaking converter dusts to a particle diameter of 50 μm; and
pig iron particles separated from blast furnace granulated slags.

23. The heavy aggregate of claim 22, wherein the heavy aggregate is obtained by mixing hot scarves and mill scales at a mixing volume ratio of from 100:0 to 30:70.

24. The heavy aggregate of claim 22, wherein the heavy aggregate is obtained by mixing:
hot scarves; and
coarse particle components obtained by sieving steelmaking converter dusts to a particle diameter of 50 μm;
wherein the hot scarves and coarse particle components are mixed at a mixing volume ratio of from 100:0 to 70:30.

25. The heavy aggregate of claim 22, wherein the heavy aggregate is obtained by mixing:
hot scarves; and
pig iron particles separated from blast furnace granulated slags;
wherein the hot scarves and coarse particle components are mixed at a mixing volume ratio of from 100:0 to 70:30.

26. A heavy aggregate comprising particles comprising at least one member selected from the group consisting of FeO, Fe₂O₃ and metallic iron as a main component;
wherein:
at least 20% of the particles are spherical particles having distortion irregularities of 3.3 or less, except when at least 20% of the particles of the aggregate are spherical particles derived from hot scarves obtained by scarfing a steel slab surface;
from 10 to 20% by mass of the particles are capable of passing through a sieve having a nominal size of 0.15 mm; and
from 70 to 90 mass % of the particles are capable of passing through a sieve having a nominal size of 1.2 mm passing through a sieve having a nominal size of 1.2 mm.

27. The heavy aggregate of claim 26, wherein the heavy aggregate is obtained by mixing materials recycled from a steelmaking process.

28. A heavy aggregate comprising particles comprising at least one member selected from the group consisting of FeO, Fe₂O₃ and metallic iron as a main component;
wherein:
at least 20% of the particles are spherical particles having distortion irregularities of 3.3 or less, except when at least 20% of the particles of the aggregate are spherical particles derived from hot scarves obtained by scarfing a steel slab surface;
from 10 to 20% by mass of the particles are capable of passing through a sieve having a nominal size of 0.15 mm; and
the heavy aggregate comprises hot scarves obtained by scarfing a steel slab surface.

29. The heavy aggregate of claim 28, wherein the heavy aggregate is obtained by mixing hot scarves with at least one member selected from the group consisting of:
mill scales obtained from a rolling process in steelmaking;
coarse particle components obtained by sieving steelmaking converter dusts to a particle diameter of 50 μm; and
pig iron particles separated from blast furnace granulated slags.

30. A heavy aggregate comprising particles comprising at least one member selected from the group consisting of FeO, Fe₂O₃ and metallic iron as a main component;
wherein:
at least 20% of the particles are spherical particles having distortion irregularities of 3.3 or less;
from 10 to 20% by mass of the particles are capable of passing through a sieve having a nominal size of 0.15 mm; and
the heavy aggregate is obtained by mixing hot scarves with at least two members selected from the group consisting of:
mill scales obtained from a rolling process in steelmaking;
coarse particle components obtained by sieving steelmaking converter dusts to a particle diameter of 50 μm; and
pig iron particles separated from blast furnace granulated slags.

31. The heavy aggregate of claim 30, wherein mill scales, coarse particle components and pig iron particles are mixed in amounts of:
20 to 70% by mass mill scales;
20 to 50% by mass coarse particle components; and
0 to 40% by mass pig iron particles.

32. A heavy aggregate comprising particles comprising at least one member selected from the group consisting of FeO, Fe₂O₃ and metallic iron as a main component;
wherein:
at least 20% of the particles are spherical particles having distortion irregularities of 3.3 or less, except when at least 20% of the particles are spherical particles derived from hot scarves obtained by scarfing a steel slab surface;
from 10 to 20% by mass of the particles are capable of passing through a sieve having a nominal size of 0.15 mm; and
the heavy aggregate comprises mill scales obtained from a rolling process in steelmaking.
